(19) United States
(12) Patent Application Publication
(10) Pub. No.: US 2007/0127904 A1
(43) Pub. Date: Jun. 7, 2007

(54) PARALLEL MOVING DEVICE, ACTUATOR, LENS UNIT, AND CAMERA

(75) Inventors: Takafumi IWASAKI, Saitama (JP); Takayoshi Noji, Saitama (JP)

Correspondence Address: FOLEY AND LARDNER LLP;SUITE 500, 3000 K STREET NW, WASHINGTON, DC, 20007, US

(73) Assignee: TAMRON CO., LTD.

(21) Appl. No.: 11/566,447

(22) Filed: Dec. 4, 2006

(30) Foreign Application Priority Data
Dec. 5, 2005 (JP) 2005-350345

(51) Int. Cl. G03B 17/00

(52) U.S. Cl. 396/55

(57) ABSTRACT

A parallel moving device includes a fixed plate provided on an enclosure side, a moving frame provided on an optical system side, and three columnar members that are provided between the fixed plate and the moving frame and that support the fixed plate and the moving frame so as to enable movement of the moving frame in a direction substantially perpendicular to an optical axis of the optical system. These columnar members are formed with an elastic member that connects the fixed plate and the moving frame in the direction along the optical axis and supports the moving frame in parallel with the fixed plate.

### BACKGROUND OF THE INVENTION

1. Field of the Invention

The present invention relates to a parallel moving device, and an actuator, a lens unit, and a camera that includes the parallel moving device.

2. Description of the Related Art

In a lens device provided with an imaging lens such as a variable magnification lens often employ a vibration-proofing device that prevents image blur caused by vibration due to hand jiggling, etc. In this type of vibration-proofing device, for example, the image blur is prevented by detecting vibration of a lens barrel housing an imaging lens, and by driving a correction lens on a plane parallel with a film so as not to cause the image blur based on the detected vibration. This type of vibration-proofing device is usually provided with a parallel moving mechanism that moves the correcting lens in parallel on a predetermined plane.

This type of parallel moving mechanism has, for example, a structure as follows. The parallel moving mechanism of a vibration-proofing device includes a fixed frame on which a correction lens is fixed, a first holding frame that slidably supports this fixed frame in a first direction perpendicular to an optical axis, and a second holding frame that slidably holds this first holding frame in a second direction substantially perpendicular to the optical axis and the first direction and that is fixed to the lens barrel.

And the correction lens is supported capable of a translational motion in an arbitrary direction in a plane parallel with a film with respect to the lens barrel by combining motions in the first and the second directions orthogonal to each other. Moreover, the vibration-proofing device provided with this type of parallel moving mechanism includes linear motors prepared exclusively for driving the correction lens in the first direction and the second direction, respectively, and the correction lens is moved in an arbitrary direction by combining driving amounts by these linear motors.

Also, in a lens device having an image blur preventing function by this type of vibration-proofing device, the parallel moving mechanism that supports the correction lens capable of parallel movement is provided with a combination of a guide unit that slidably guides the correction lens in a predetermined direction and a driving unit that drives the correction lens in that direction in each of the orthogonally crossing two directions (an X direction and a Y direction, for example) so as to move the correction lens in an arbitrary direction and to prevent the image blur (for example, Japanese Patent Application Laid-Open Publication No. H3-186823).

However, the conventional vibration-proofing device described in the above patent document has a problem that since the image blur is prevented by the parallel moving mechanism constructed by combining the guide unit arranged in the two directions orthogonal to each other and the driving units in those directions, a support mechanism of the fixed frame, and the holding frame can be complicated, for example. And if the support mechanism becomes complicated, weight of a movable part of the parallel moving mechanism increases, there by making high-speed and linear parallel movement difficult.

Furthermore, since sliding resistance is generated between the parallel moving mechanism and the guide unit in the conventional vibration-proofing device, controllability of the parallel moving mechanism is deteriorated. Moreover, an actuator using the guide units can move a movable part translationally in an arbitrary direction on a predetermined plane but the actuator can not move the movable part rotationally around the optical axis.

The guide unit or the support mechanism of the parallel moving mechanism in this structure requires some clearance to enable movement with small friction. Therefore, unintentional movement in a space corresponding to this clearance may occur, thereby causing a positioning error. In addition, if such clearance is provided, a load relating to driving is different between movement without contact between members and movement while sliding, thereby deteriorating control accuracy.

### SUMMARY OF THE INVENTION

It is an object of the present invention to at least solve the above problem in the conventional technologies.

A parallel moving device according to one aspect of the present invention includes a fixed member that is mounted on the lens barrel; a movable member on which an image stabilizing lens is mounted; and a support member that is provided between the fixed member and the movable member to support both of the fixed member and the movable member while enabling movement of the movable member in a direction substantially perpendicular to an optical axis of the image stabilizing lens. The support member connects the fixed member and the movable member in a direction along the optical axis, and is formed with an elastic member that supports the movable member in parallel with the fixed member.

An actuator according to another aspect of the present invention includes a fixed member that is mounted on the lens barrel; a movable member on which an image stabilizing lens is mounted; a support member that is provided between the fixed member and the movable member to support both of the fixed member and the movable member while enabling movement of the movable member in a direction substantially perpendicular to an optical axis of the image stabilizing lens; at least three driving coils that are provided at either one of the fixed member and the movable member; a plurality of driving magnets that are provided at another one of the fixed member and the movable member such that each of the driving magnets is arranged at a portion corresponding to one of the driving coils respectively; a position detecting unit that detects positions of the driving magnets with respect to the driving coils based on action of a magnetic field; and a control unit that generates a coil position signal for each of the driving coils based on a signal indicating a position to which the movable member is to be moved so as to cancel vibration externally applied, and that controls a driving current to be fed to each of the driving coils, based on the coil position signal and a result of detection by the position detecting unit. The support member connects the fixed member and the movable member in a direction along the optical axis, and is formed with an elastic member that supports the movable member in parallel with the fixed member.

A lens unit according to still another aspect of the present invention includes a lens barrel that accommodates a lens; a fixed member that is mounted on the lens barrel; a movable member on which an image stabilizing lens is mounted; a support member that is provided between the fixed member and the movable member to support both of the fixed member and the movable member while enabling movement of the movable member in a direction substantially perpendicular to an optical axis of the image stabilizing lens; at least three driving coils that are provided at either one of the fixed member and the movable member; a plurality of driving magnets that are provided at another one of the fixed member and the movable member such that each of the driving magnets is arranged at a portion corresponding to one of the driving coils respectively; a position detecting unit that detects positions of the driving magnets with respect to the driving coils based on action of a magnetic field; a vibration detecting unit that detects vibration of the lens barrel; a lens position signal generating unit that generates a lens position signal indicating a position to which the image stabilizing lens is to be moved, based on a result of detection by the vibration detecting unit; and a control unit that generates a coil position signal for each of the driving coils based on the lens position signal, and that controls a driving current to be fed to each of the driving coils, based on the coil position signal and a result of detection by the position detecting unit. The support member connects the fixed member and the movable member in a direction along the optical axis, and is formed with an elastic member that supports the movable member in parallel with the fixed member.

A camera according to still another aspect of the present invention includes the lens unit according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-section of a camera according to a first embodiment of the present invention;

FIG. 2 is a cross-section of a front part of an actuator in the camera according to the first embodiment;

FIG. 3 is an exploded view of the actuator according to the first embodiment;

FIG. 4 is a cross-section of the actuator taken along a line A-A shown in FIG. 2;

FIG. 5 is a cross-section of the actuator;

FIG. 6A is a perspective view of a parallel moving device provided at the actuator provided at the camera according to the first embodiment of the present invention;

FIG. 6B is a perspective view of a parallel moving device provided at the actuator provided at the camera according to the first embodiment of the present invention;

FIG. 7A is an enlarged side view of the actuator showing a positional relation between a driving coil and a driving magnet;

FIG. 7B is an explanatory diagram showing a magnetization direction and magnetic flux distribution in the driving coil and the driving magnet;

FIG. 7C is an enlarged front view of the actuator showing the positional relation between the driving coil and the driving magnet;

FIG. 8A is an explanatory diagram for explaining a relation between movement of the driving magnet and a signal output from the magnetic sensor;

FIG. 8B is an explanatory diagram for explaining the relation between the movement of the driving magnet and the signal output from the magnetic sensor;

FIG. 9A is an explanatory diagram for explaining the relation between the movement of the driving magnet and the signal output from the magnetic sensor;

FIG. 9B is an explanatory diagram for explaining the relation between the movement of the driving magnet and the signal output from the magnetic sensor;

FIG. 9C is an explanatory diagram for explaining the relation between the movement of the driving magnet and the signal output from the magnetic sensor;

FIG. 9D is an explanatory diagram for explaining the relation between the movement of the driving magnet and the signal output from the magnetic sensor;

FIG. 10 is a block diagram for explaining signal processing in a controller provided in a lens unit of the camera according to the first embodiment;

FIG. 11 is an explanatory diagram showing a positional relation between three driving coils arranged on a fixed plate and three driving magnets arranged on the moving frame;

FIG. 12 is an explanatory diagram for explaining a coil position command signal when the moving frame makes translational motion and rotational motion;

FIG. 13 is a circuit diagram of a circuit that controls an electric current output to the driving coil;

FIG. 14 is a diagram for explaining modification of arrangement of the driving magnets of the actuator provided in the camera according to the first embodiment;

FIG. 15 is a view for explaining another modification of the actuator provided at the camera according to the first embodiment; and

FIG. 16 is a partial broken view of a front part of a parallel moving device according to a second embodiment of the present invention;

FIG. 17 is a side cross-section of the parallel moving device according to the second embodiment;

FIG. 18 is a rear view of the parallel moving device according to the second embodiment;

FIG. 19 is a partial broken view of a front part of a parallel moving device according to a third embodiment of the present invention;

FIG. 20 is a side cross-section of the parallel moving device according to the third embodiment; and

FIG. 21 is a rear view of the parallel moving device according to the third embodiment.

### DETAILED DESCRIPTION OF THE PREFERRED EMBODIMENTS

Exemplary embodiments of the present invention will be described below in detail with reference to the accompanying drawings.

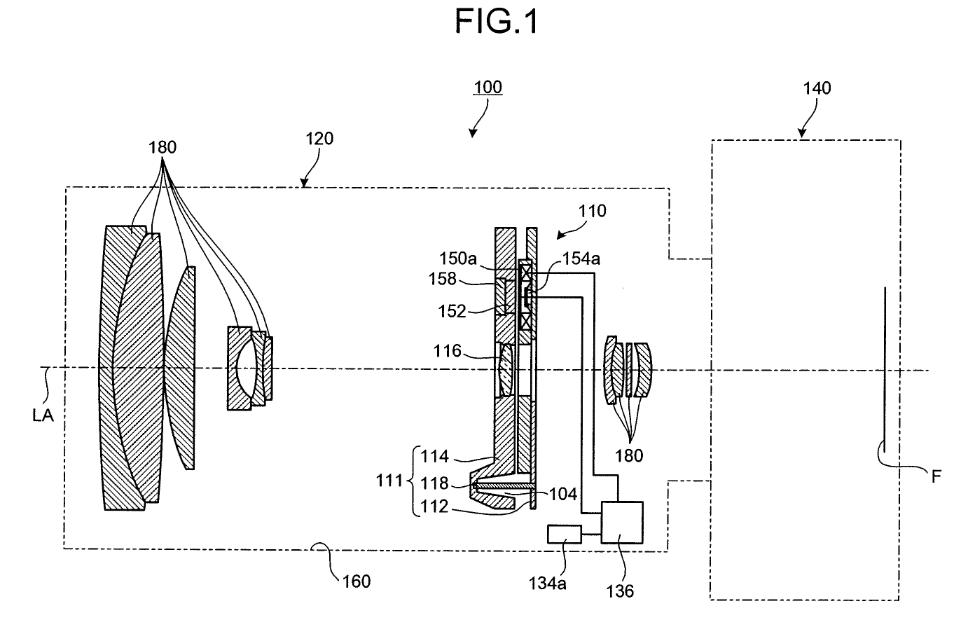

FIG. 1 is a cross-section of a camera according to a first embodiment of the present invention. As shown in FIG. 1, a camera 100 includes a lens unit 120 and a camera body 140. The lens unit 120 includes a lens barrel 160 having an enclosure formed in a cylindrical shape, for example, an imaging lens 180 constituted of a plurality of lenses disposed inside the lens barrel 160, an actuator 110 that moves an image stabilizing lens 116 in a predetermined plane, and gyros 134a, 134b (only the gyro 134a is shown in FIG. 1) as a vibration detecting unit that detects vibration of the lens barrel 160.

In the camera 100 constructed as above, vibration of the lens barrel 160 is detected by the gyros 134a, 134b, and the actuator 110 is operated based on the detected vibration so as to move the image stabilizing lens 116 in an arbitrary direction in a plane in a direction substantially perpendicular to an optical axis LA so that an image focused on a film face F of the camera body 140 is stabilized. The actuator 110 includes a parallel moving device 111, which will be described later, having a fixed plate 112 fixed to the lens barrel 160, a moving frame 114 on which the image stabilizing lens 116 is mounted, and a columnar member 118 that supports them in parallel and a driving unit.

In the camera 100 according to this first embodiment, a piezoelectric vibration gyro is used as the gyros 134a, 134b, but gyros in other structures may be used. The image stabilizing lens 116 includes a single lens in this first embodiment, but it may include a plurality of lenses to stabilize an image to be focused on the film face F. In the following, the image stabilizing lens 116 includes a lens group included by a plurality of lenses as well as a single lens for stabilizing an image.

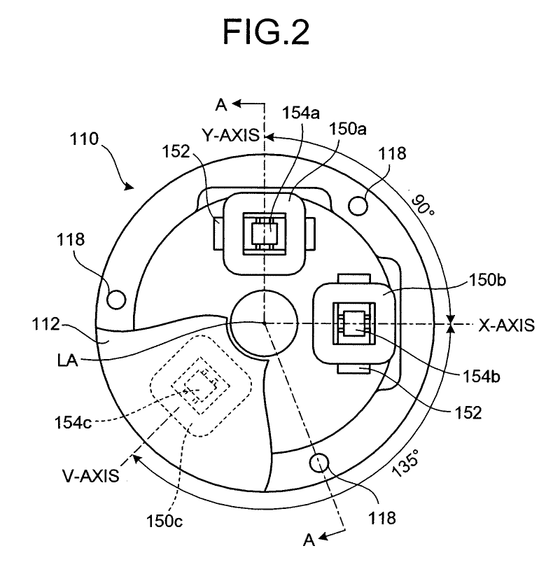

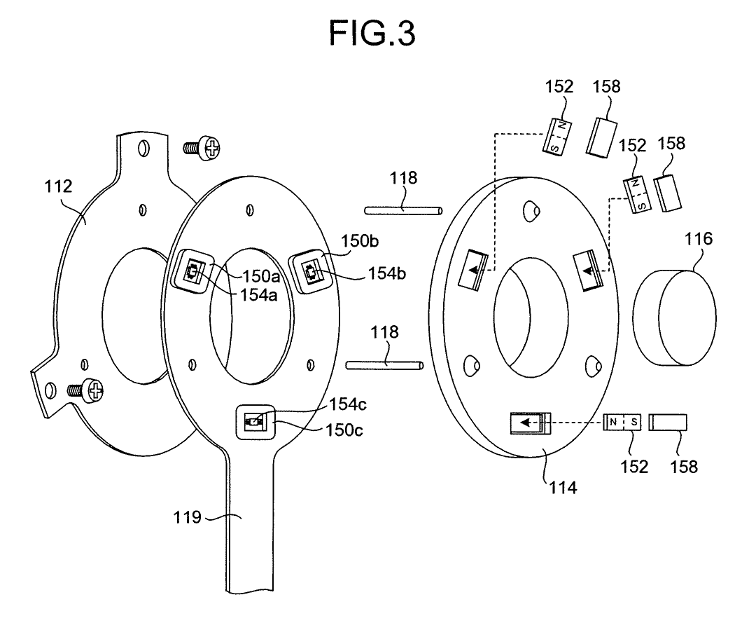

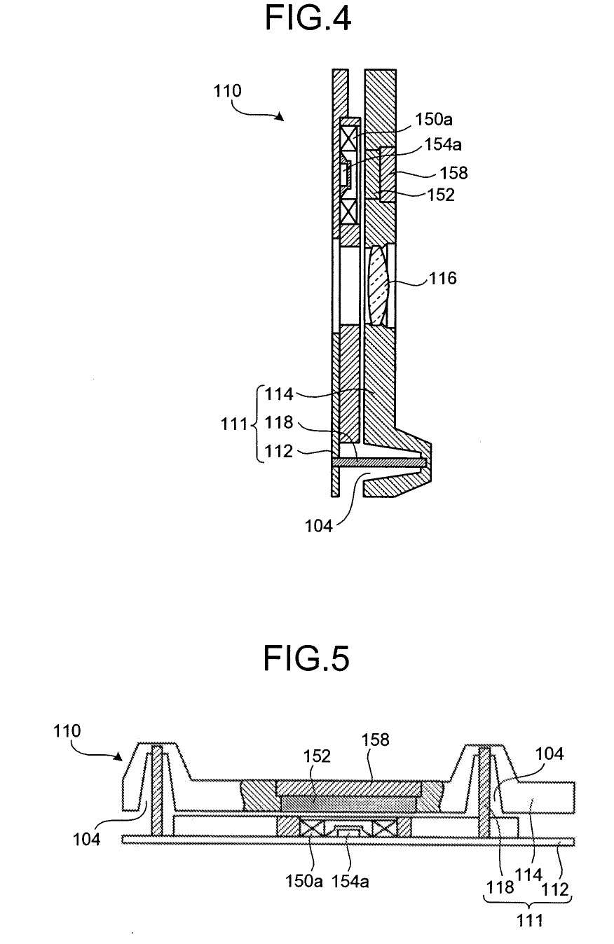

FIG. 2 is a cross-section of a front part of the actuator provided in the camera according to the first embodiment. FIG. 3 is an exploded view of the actuator. FIG. 4 is a cross-section of the actuator taken along a line A-A shown in FIG. 2. FIG. 5 is a partial side cross-section of the actuator.

FIG. 2 illustrates the actuator 110 seen from the film face F side of the camera body 140 in FIG. 1, and the fixed plate 112 of the actuator 110 is shown in the partially broken manner, but this view is referred to as a front view for convenience.

As shown in FIGS. 2 to 5, the actuator 110 includes the parallel moving device 111 provided with the fixed plate 112, which is a fixed member fixed inside the lens barrel 160 of the camera 100, the moving frame 114, which is a moving member supported movably with respect to this fixed plate 112, and the rod-like columnar member 118, which is a support member that supports the moving frame 114 in parallel with the fixed plate 112.

It is only necessary that the columnar member 118, which is a support member, is disposed in plurality between the fixed plate 112 and the moving frame 114, and there are three members disposed herein. These three columnar members 118 constitute a movable-member supporting unit that supports the moving frame 114, which is a movable member, with respect to the fixed plate 112, which is a fixed member. These columnar members 118 connect the fixed plate 112 and the moving frame 114 with their axes parallel with the optical axis LA in the direction along the optical axis LA.

The columnar member 118 supporting the fixed plate 112 and the moving frame 114 is formed having appropriate elasticity and flexibility by a resin material (soft resin material), a rubber material or a flexible material, for example, to have a rod-like or a columnar appearance as mentioned above. The columnar member 118 may be formed in a rod-like or a columnar state with a circular, an oval, a rectangular or any other section in the direction perpendicular to its axial direction, for example.

The columnar member 118 may also be formed by a rigid material or rigid resin material. In this case, the columnar member 118, 218, 318 may be formed in the shape that can obtain appropriate elasticity and flexibility even if a rigid material is used by decreasing the entire thickness or the outer circumferential diameter.

Both ends in the axial direction of these columnar members 118 are connected to, for example, the fixed plate 112 and the moving frame 114, respectively. Therefore, the columnar member 118 also functions as a fixing member that fixes the fixed plate 112 and the moving frame 114 in a predetermined positional relation. Also, the columnar member 118 may be integrally formed at least one of the fixed plate 112 and the moving frame 114. If the columnar member 118 is integrally formed with the fixed plate 112 or the moving frame 114, assembling work of the parallel moving device 111 can be further facilitated.

At a disposed position of the columnar member 118 in the moving frame 114, a recess portion 104 having an opening in the direction opposite to the fixed plate 112 (see FIGS. 1, 4, and 5, for example) is formed, and at the farthest portion in the optical axis LA direction in this recess portion 104, the end in the axial direction of the columnar member 118 is connected. Also, this recess portion 104 may be also formed to have an opening in the direction opposite to the moving frame 114 not only in the moving frame 114 or only at the fixed plate 112 at the disposed position of the columnar member 118 in the fixed plate 112.

By providing the recess portion 104 at the disposed position of the columnar member 118 at least at one of the fixed plate 112 and the moving frame 114 in this way, a predetermined interval is formed between the fixed plate 112 and the moving frame 114 to support the both while the axial length of the columnar member 118 is ensured to some extent.

Therefore, such a structure is realized that the moving frame 114 is not brought into contact with the fixed plate 112 at movement of the moving frame 114 and a moving amount of the columnar member 118 in the optical axis LA direction caused by deflection can be made smaller against a moving amount of the moving frame 114 in the direction substantially perpendicular to the optical axis LA by increasing the axial length of the columnar member 118. By this, the moving frame 114 can be moved by a small moving amount while ensuring a sufficient length or deflection amount of the columnar member 118, and smooth parallel movement of the moving frame 114 with respect to the fixed plate 112 can be realized.

The actuator 110 includes three driving coils 150a, 150b, 150c mounted on the fixed plate 112 through a flexible substrate 119 (see FIG. 3), for example, three driving magnets 152 made of permanent magnets mounted at positions corresponding to the three driving coils 150a to 150c, respectively, in the moving frame 114, and magnetic sensors 154a, 154b, 154c, which are position detecting units disposed inside each of the driving coils 150a to 150c for detection of the position of each driving magnet 152 with respect to each of the driving coils 150a to 150c, respectively.

The actuator 110 has back yokes 158 (see FIGS. 3 to 5) mounted on the back of each driving magnet 152 to effectively direct a magnetic force of each driving magnet 152 to the direction of the fixed plate 112. Also, each of the driving coils 150a to 150c on the fixed plate 112 side and each driving magnet 152 at the corresponding position on the moving frame 114 side constitute a driving unit for translational motion and rotational motion of the moving frame 114 with respect to the fixed plate 112.

Moreover, the actuator 110 has, as shown in FIG. 1, a controller 136 as a control unit that controls a driving current flowing to each of the driving coils 150a to 150c on the fixed plate 112 side based on vibration of the lens barrel 160 detected by the gyros 134a, 134b and a position detection result (position information) of the moving frame 114 detected by each of the magnetic sensors 154a to 154c.

The lens unit 120 of the camera 100 according the first embodiment is mounted on the camera body 140 and constructed so that light incident into the lens barrel 160 is made to form an image on the film face F of the camera body 140 through the imaging lens 180 and the image stabilizing lens 116. In the lens barrel 160 of the lens unit 120, the imaging lens 180 made of a plurality of lenses as mentioned above is held and is provided with a structure capable of so-called focus adjustment by moving at least a part of the imaging lens 180 in the optical axis LA direction.

The actuator 110 constructed as above is driven so that the image stabilizing lens 116 mounted on the moving frame 114 by moving the moving frame 114 in a plane parallel with the film face F in the camera body 140 with respect to the fixed plate 112 fixed to the lens barrel 160 as mentioned above so that an image formed on the film face F is not blurred even if vibration is generated in the lens barrel 160. Moving operation of the actuator 110 by the parallel moving device 111 will be briefly described.

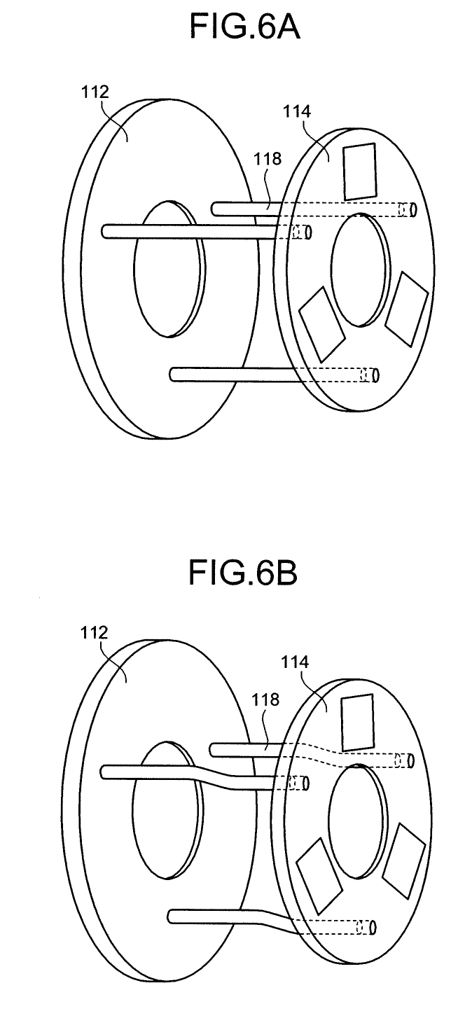

FIGS. 6A and 6B are perspective views schematically showing the parallel moving device provided at the actuator. In the parallel moving device shown in FIGS. 6A and 6B, the columnar members 118 are mounted on the moving frame 114 not through the above-mentioned recess portion 104. With this parallel moving device, when the moving frame 114 is not driven by the actuator 110, the moving frame 114 is held in parallel with the fixed plate 112 by the three columnar members 118 in the upright state as shown in FIG. 6A.

On the other hand, when the moving frame 114 is driven by the actuator 110, as shown in FIG. 6B, the moving frame 114 is moved in parallel with the fixed plate 112 while being supported in parallel by deflection of the three columnar members 118 in the moving direction of the moving frame 114. Therefore, the moving frame 114 can be made capable of translational motion or rotational motion in the plane parallel with the fixed plate 112 freely.

As shown in FIG. 2, the fixed plate 112 of the parallel moving device 111 is made of a doughnut-shaped disk member having a space at the center part and is constructed with the three driving coils 150a to 150c disposed on one disk face. These three driving coils 150a to 150c are arranged on the fixed plate 112 so that their center parts are arranged on the circumference around the optical axis LA of the lens unit 120.

In this first embodiment, the driving coil 150a, for example, is arranged at a position perpendicularly above (on Y-axis in FIG. 2) the optical axis LA of the lens unit 120, the driving coil 150b at a position (on X-axis in FIG. 2) horizontal to the optical axis LA, and the driving coil 150c at a position (on V-axis in FIG. 2) in the direction perpendicular to the optical axis LA separated from the driving coil 150a and the driving coil 150b by a center angle of 135°, respectively.

Therefore, the driving coil 150a and the driving coil 150b are separated by a center angle of 90°, the driving coil 150b and the driving coil 150c separated by a center angle of 135°, and the driving coil 150c, and the driving coil 150a separated by a center angle of 135°. Also, the driving coils 150a to 150c are wound by windings in the rectangular state with their corners rounded and arranged on the fixed plate 112 so that the center line of the rectangle matches the radial direction of the circumference.

On the other hand, the moving frame 114 of the parallel moving device 111 is made of a doughnut-shaped disk member having a space at the center part, for example, as with the fixed plate 112 and arranged so that it is overlapped with the fixed plate 112 in parallel. At an opening at the center of the moving frame 114, the image stabilizing lens 116 is mounted. And at positions corresponding to the driving coils 150a to 150c on the circumference of the moving frame 114, the driving magnets 152 in the rectangular shape, for example, are embedded, respectively.

The positions corresponding to the driving coils 150a to 150c represent the positions to which a magnetic field formed by the driving coils 150a to 150c actually prevails. On the back sides of the driving magnets 152, that is, on the side opposite to the driving coils 150a to 150c, rectangular back yokes 158 are mounted so that a magnetic flux of the driving magnets 152 is efficiently directed to the direction of the fixed plate 112.

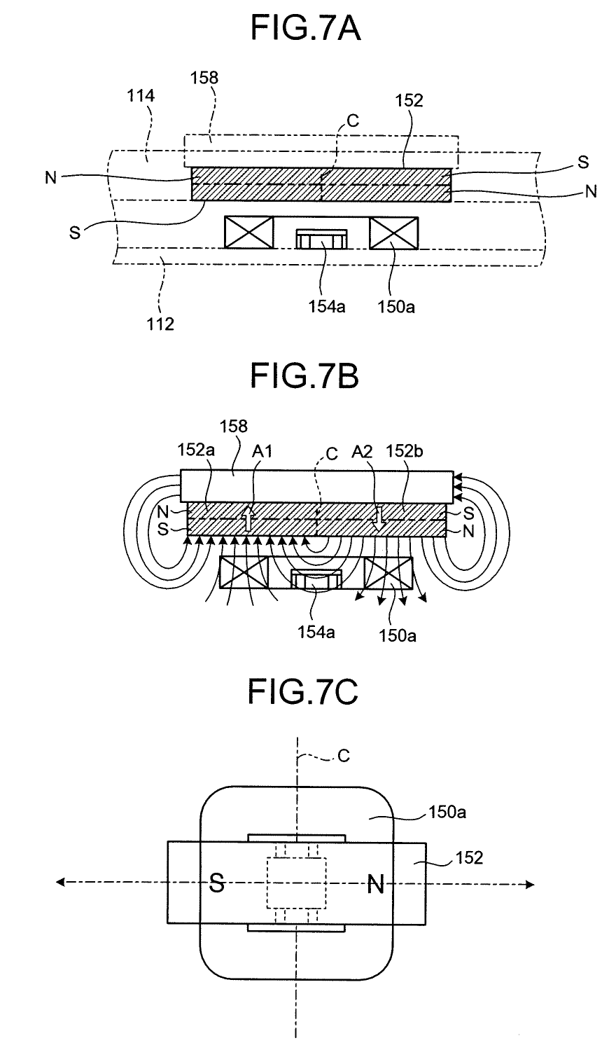

FIG. 7A is a partially enlarged side view of the actuator showing a positional relation between the driving coil and the driving magnet. Also, FIG. 7B is a diagram for explaining magnetization direction and magnetic flux distribution of the driving coil and the driving magnet. FIG. 7C is a partially enlarged front view of the actuator showing a positional relation between the driving coil and the driving magnet. As shown in FIGS. 2, 7A to 7C, the driving magnet 152 and the back yoke 158 having the rectangular shape, respectively, are arranged so that each long side and each short side are overlapped with each other.

Also, the driving coil 150a is arranged so that each side in the rectangle becomes parallel with each long side and short side of the rectangular back yoke 158. Moreover, the driving magnet 152 is oriented so that its magnetization border line C matches the radial direction of the circumference where each driving magnet 152 is arranged.

By this, when electricity flows through the corresponding driving coil 150a, the driving magnet 152 receives a driving force in the tangent direction of the circumference. For the other driving coils 150b, 150c, too, the corresponding driving magnets 152 and the back yokes 158 in the similar positional relation are arranged, respectively.

The magnetization border line C refers to a line representing a border between two regions when the two regions of the driving magnet 152 are magnetized in directions different from each other, for example. In this first embodiment, the magnetization border line C is located close to the middle point of magnetized regions 152a, 152b of the rectangular driving magnet 152, for example (see FIG. 7B).

As shown in FIGS. 7A and 7B, the driving magnet 152 is magnetized so that the magnetic flux is directed to the direction perpendicular to the face opposite to the driving coil 150a such that the lower left part from the magnetization border line C is magnetized as the S pole, the lower right part as the N pole, the upper left part as the N pole and the upper right part as the S pole, for example, so as to form the magnetized regions 152a, 152b.

Therefore, a magnetic line from the driving magnet 152 can be represented in the state as shown in FIG. 7B, and a direction A1 of the magnetic flux in the magnetized region 152a of the left part from the magnetization border line C is, as shown by an outline arrow in the Figure, represented to be directed to the direction of the back yoke 158. Also, a direction A2 of the magnetic flux in the magnetized region 152b of the right part from the magnetization border line C is, as shown by an outline arrow in the Figure, represented to be directed to the direction of the driving coil 150a.

As shown in FIGS. 2 to 5, FIGS. 7A to 7C, in the inner gap part of each of the driving coils 150a to 150c, the magnetic sensors 154a, 154b, 154c are arranged, respectively. Each of the magnetic sensors 154a to 154c is arranged so that a sensitivity center point S (not shown), which will be described later, is located on the magnetization border line C of each of the driving magnets 152 and becomes magnetically neutral when the moving frame 114 is at a neutral position with respect to the fixed plate 112.

Magnetically neutral means, as shown in FIG. 7B, a state where the above-mentioned magnetic flux direction in the driving magnet 152 becomes perpendicular to the detection direction of the magnetic sensor 154a and the output of the magnetic sensor 154a indicates the same value as that when there is no magnetic field. In the first embodiment, a hall element or the like is used as the magnetic sensors 154a to 154c, for example.

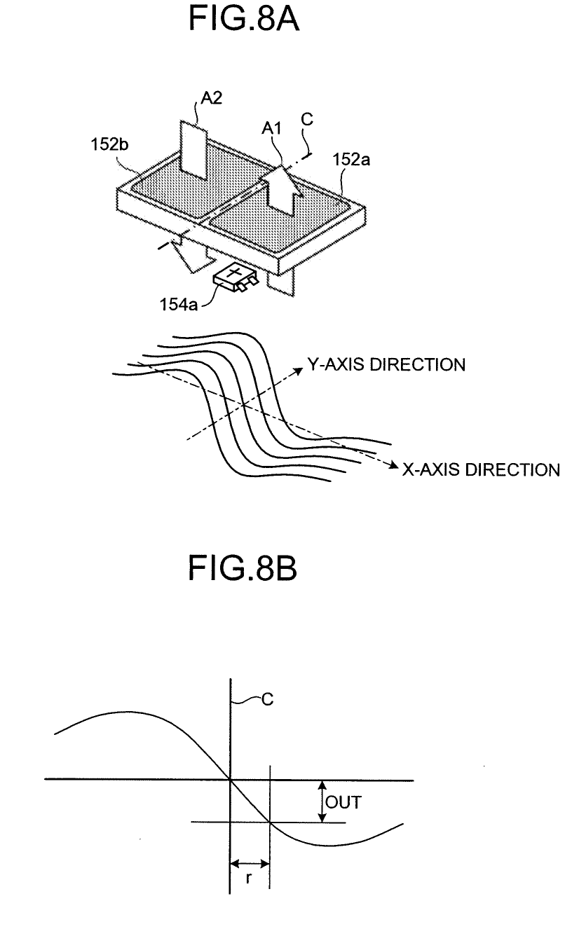

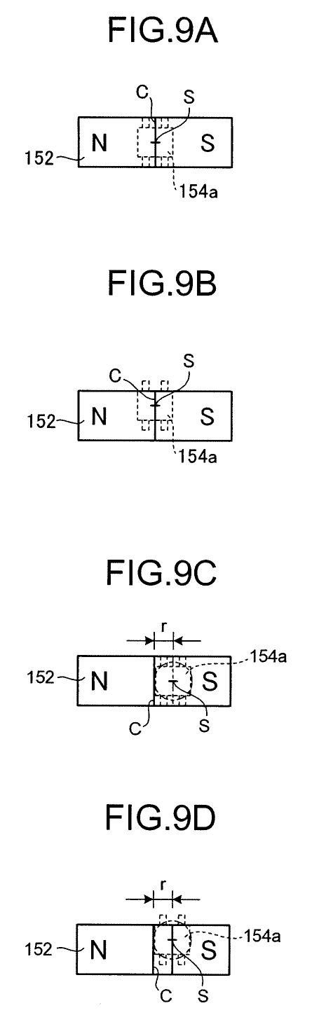

FIGS. 8A, 8B and 9A to 9D are explanatory diagrams for explaining the relation between movement of the driving magnet and a signal output from the magnetic sensor. As shown in FIGS. 8A and 8B, when the sensitivity center point S of the magnetic sensor 154a is located on the magnetization border line C of the driving magnet 152, the output from the magnetic sensor 154a becomes 0.

When the driving magnet 152 is moved with the moving frame 114 and the sensitivity center point S of the magnetic sensor 154a is displaced from the magnetization border line C of the driving magnet 152 to the N pole side or the S pole side, an output signal Out of the magnetic sensor 154a (see FIG. 8B) is changed to positive or negative.

When the driving magnet 152 is moved to the direction perpendicular to the magnetization border line C, that is, in the X-axis direction in FIG. 8A, the magnetic sensor 154a generates the output signal Out changed in the sinusoidal wave state as shown in FIG. 8B. Therefore, if a movement amount of the driving magnet 152 is very small, the magnetic sensor 154a output the output signal Out substantially in proportion to a distance r from the sensitivity center point S to the magnetization border line C of the driving magnet 152.

In the first embodiment, if a moving distance of the driving magnet 152 is within about 3% of the length of the driving magnet 152 in the distance detecting direction, the output signal Out output from the magnetic sensor 154a is substantially in proportion to a distance r between the sensitivity center point S of the magnetic sensor 154a and the magnetization border line C of the driving magnet 152. And in this first embodiment, the actuator 110 is operated within a range where the output of each of the magnetic sensors 154a to 154c is substantially in proportion to the distance r.

Therefore, as shown in FIGS. 9A and 9B, when the magnetization border line C of the driving magnet 152 is located on the sensitivity center point S of the magnetic sensor 154a or when the driving magnet 152 has been moved in the direction of the magnetization border line C as shown in FIG. 9B, for example, the output signal Out from the magnetic sensor 154a becomes 0.

Also, as shown in FIG. 9C, if the magnetization border line C of the driving magnet 152 is displaced from the sensitivity center point S of the magnetic sensor 154a, the positive or negative output signal Out in proportion to the distance r between the sensitivity center point S and the magnetization border line C is output from the magnetic sensor 154a.

Therefore, if the distance r between the sensitivity center point S and the magnetization border line C is the same, for example, the positive or negative output signal Out in the same size is output from the magnetic sensor 154a if the driving magnet 152 is moved in the direction perpendicular to the magnetization border line C as shown in FIG. 9C or if the driving magnet 152 makes translational movement in an arbitrary direction as shown in FIG. 9D.

The case of the magnetic sensor 154a has been described, but the other magnetic sensors 154b, 154c also output the similar output signal Out based on the positional relation with the corresponding driving magnets 152. Therefore, specification of the position after translational movement or rotational movement of the moving frame 114 with respect to the fixed plate 112 becomes possible based on the signal detected by each of the magnetic sensors 154a to 154c.

As shown in FIG. 2, the three columnar members 118 are arranged on the circumference outside of the circumference where each of the driving coils 150a to 150c of the fixed plate 112 is arranged between the fixed plate 112 and the moving frame 114 while the axis is made parallel with the optical axis LA direction. These three columnar members 118 are arranged with an interval of a center angle of 120°, respectively, and one of them is arranged so that it is located between the driving coil 150a and the driving coil 150b.

As shown in FIGS. 3 to 5, each columnar member 118 is arranged between the fixed plate 112 and the moving frame 114 so that both ends in the axial direction are connected to the fixed plate 112 and the moving frame 114, respectively. By this, the moving frame 114 is supported on the plane in parallel with the fixed plate 112, and when each columnar member 118 is deformed while being deflected between the moving frame 114 and the fixed plate 112, the translational motion or rotational motion in an arbitrary direction of the moving frame 114 with respect to the fixed plate 112 is allowed.

A predetermined interval is formed between the fixed plate 112 and the moving frame 114, while being supported by the columnar members 118. Therefore, when the moving frame 114 is moved with respect to the fixed plate 112, no sliding friction or resistance by contact is caused between them, but smooth translational or rotational motion can be made.

The columnar member 118 in the first embodiment is constructed by a rod-like resin molding member that is hard to be plastically deformed and is provided with elasticity as mentioned above, but it may be constructed by steel wire, phosphor bronze, elastomer or the like. Also, the columnar member 118 may be integrally molded with at least one of the fixed plate 112 and the moving frame 114 or formed separately and inserted into the fixed plate 112 and the moving frame 114 and mounted/fixed. The section in the direction substantially perpendicular to the axial direction of the columnar member 118 does not necessarily have to be circular but it may be a rectangular section and the like.

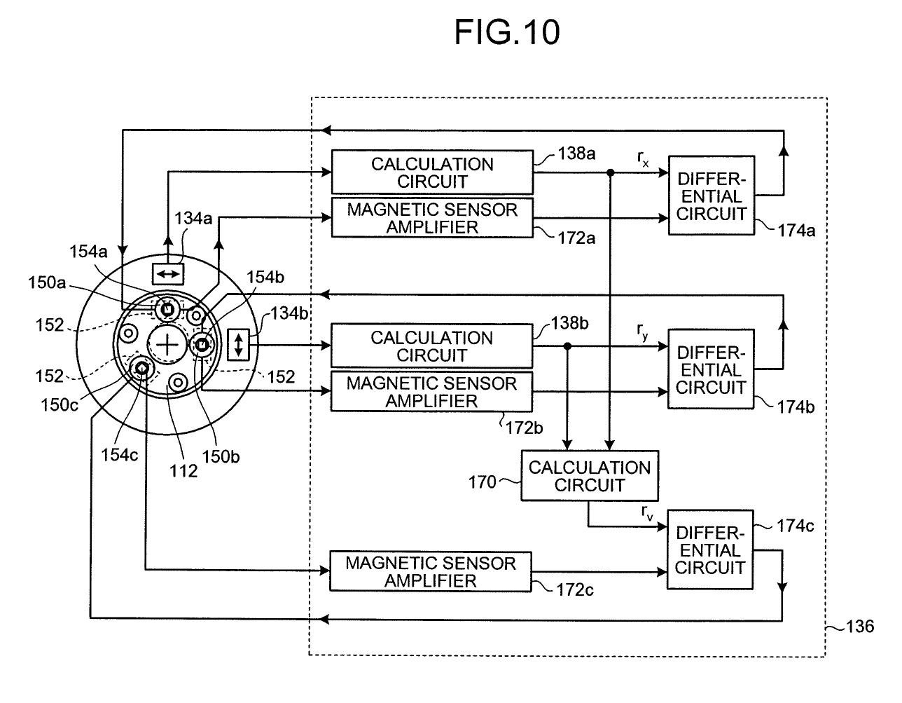

Next, control of the actuator 110 provided at the camera 100 according to the first embodiment will be described referring to FIG. 10. FIG. 10 is a block diagram showing a path of a signal processing at a controller provided at the lens unit of the camera. As shown in FIG. 10, vibration of the lens unit 120 (see FIG. 1) is detected from hour to hour by the two gyros 134a, 134b, and the detection signals from these gyros 134a, 134b are input to calculation circuits 138a, 138b, which are lens position command signal generating units incorporated in the controller 136, respectively.

In the first embodiment, the gyro 134a is constructed to detect an angular velocity of a yawing motion of the lens unit 120 and the gyro 134b for an angular velocity of a pitching motion of the lens unit 120, respectively, and they are arranged inside the lens unit 120.

The calculation circuits 138a, 138b of the controller 136 generate a lens position command signal commanding the position to which the image stabilizing lens 116 mounted on the moving frame 114 (see FIG. 1) should be moved in a time series based on the detection signal of the angular velocity input from hour to hour from the gyros 134a, 134b.

That is, the calculation circuit 138a carries out time integration of the angular velocity of the yawing motion detected by the gyro 134a and generates a horizontal component of the lens position command signal by adding a predetermined modification signal. Similarly, the calculation circuit 138b is constructed to generate a vertical component of the lens position command signal on the basis of the angular velocity of the pitching motion detected by the gyro 134b.

According to the lens position command signal obtained in this way, by moving the image stabilizing lens 116 together with the moving frame 114 from hour to hour, even if the lens unit 120 is vibrated during exposure such as photographing, an image focused on the film face F in the camera body 140 is not disturbed but stabilized.

A coil position command signal generating unit built in the controller 136 is constructed to generate a coil position command signal to each of the driving coils 150a to 150c based on the lens position command signal generated by the operation circuits 138a, 138b. The coil position command signal is a signal representing a positional relation between each of the driving coils 150a to 150c and the corresponding driving magnets 152 when the image stabilizing lens 116 is moved with the moving frame 114 to a position specified by the lens position command signal.

That is, when the driving magnets 152 arranged at the positions corresponding to each of the driving coils 150a to 150c are moved to the positions specified by the coil position command signal to each of the driving coils 150a to 150c, as a result, the image stabilizing lens 116 is moved with the moving frame 114 to the position specified by the lens position command signal.

In this first embodiment, since the driving coil 150a is provided at a position vertically above the optical axis LA (see FIG. 1), the coil position command signal to the driving coil 150a becomes equal to the horizontal component of the lens position command signal output from the calculation circuit 138a. Also, since the driving coil 150b is provided at the position in the horizontal direction (lateral direction) with respect to the optical axis LA, the coil position command signal to the driving coil 150b becomes equal to the vertical component of the lens position command signal output from the calculation circuit 138b. Moreover, the coil position command signal to the driving coil 150c is generated by a calculation circuit 170, which is the coil position command signal generating unit, based on the horizontal component and the vertical component of the lens position command signal.

On the other hand, a moving amount of the driving magnet 152 with respect to the driving coil 150a measured by the magnetic sensor 154a is amplified with a predetermined magnification by a magnetic sensor amplifier 172a. And a differential circuit 174a outputs an electric current corresponding to a difference between the horizontal component of the coil position command signal output from the calculation circuit 138a and a movement amount of the driving magnet 152 to the driving coil 150a output from the magnetic sensor amplifier 172a to the driving coil 150a.

Therefore, when the difference between the coil position command signal from the calculation circuit 138a and the output from the magnetic sensor amplifier 172a does not exist any more, the electric current is not output from the differential circuit 174a to the driving coil 150a any more, and a driving force acting on the driving magnet 152 at the position corresponding to the driving coil 150a becomes 0.

Similarly, the moving amount of the driving magnet 152 with respect to the driving coil 150b measured by the magnetic sensor 154b is amplified to a predetermined magnification by a magnetic sensor amplifier 172b. And a differential circuit 174b outputs an electric current corresponding to the difference between the vertical component of the coil position command signal output from the calculation circuit 138b and the moving amount of the driving magnet 152 with respect to the driving coil 150b output from the magnetic sensor amplifier 172b to the driving coil 150b.

Therefore, when the difference between the coil position command signal from the calculation circuit 138b and the output from the magnetic sensor amplifier 172b does not exist any more, the electric current is not output from the differential circuit 174b to the driving coil 150b, and a driving force acting on the driving magnet 152 at the position corresponding to the driving coil 150b becomes 0.

Also, the moving amount of the driving magnet 152 with respect to the driving coil 150c measured by the magnetic sensor 154c is amplified to a predetermined magnification by a magnetic sensor amplifier 172c. And a differential circuit 174c outputs an electric current corresponding to the difference between the coil position command signal output from the calculation circuit 170 and the moving amount of the driving magnet 152 with respect to the driving coil 150c output from the magnetic sensor amplifier 172c to the driving coil 150c.

Therefore, when there is no difference between the coil position command signal from the calculation circuit 170 and the output from the magnetic sensor amplifier 172c any more, the electric current is not output from the differential circuit 174c to the driving coil 150c any more, and a driving force acting on the driving magnet 152 at the position corresponding to the driving coil 150c becomes 0. By executing feedback control for the driving coils 150a to 150c on the basis of the lens position command signal and the coil position command signal in this way, the position of the image stabilizing lens 116 is corrected.

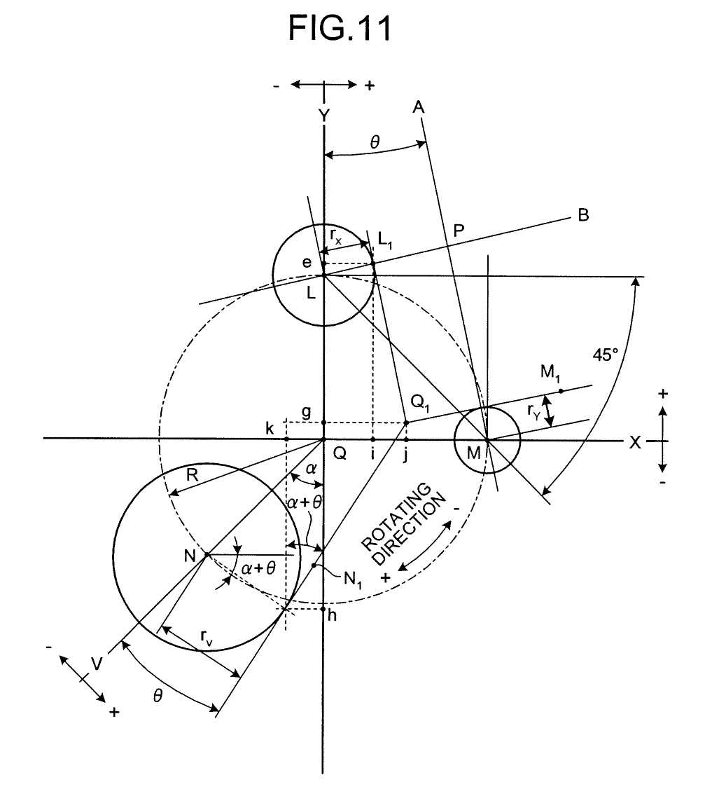

Next, the relation between the lens position command signal and the coil position command signal when the moving frame 114 makes translational motion will be described referring to FIG. 11. FIG. 11 is an explanatory diagram showing a positional relation between the three driving coils arranged on the fixed plate and the three driving magnets arranged on the moving frame.

The three driving coils 150a to 150c (not shown, the same applies in the following to FIG. 11) are arranged with their respective center points on points L, M, N on the circumference with a radius R at a point Q as the origin. Also, the magnetic sensors 154a to 154c (not shown, the same applies in the following to FIG. 11) are arranged with their respective sensitivity center points S on the points L, M, N.

Moreover, when the moving frame 114 is at the neutral position, that is, the center of the image stabilizing lens 116 mounted on the moving frame 114 is on the optical axis LA (see FIG. 1), the middle point of the magnetization border line C of each of the driving magnets 152 corresponding to each of the driving coils 150a to 150c is also located on the points L, M, N, respectively.

Suppose that a horizontal axis having the point Q as the origin in FIG. 11 as the X-axis, a vertical axis as the Y-axis and an axis forming an angle of 135° with each of the X-axis and the Y-axis as the V-axis, the magnetization border line C of each of the driving magnets 152 is at the position overlapping the X-axis, Y-axis and V-axis, respectively.

If the moving frame 114 is moved and the center point of the image stabilizing lens 116 is moved to a point Q₁ and the moving frame 114 is rotated counterclockwise by an angle θ with the point Q₁ as the center, the middle point of the magnetization border line C of each of the driving magnets 152 is moved to points L₁, M₁, N₁, respectively.

In order that the moving frame 114 is moved to this position, it is necessary that the size of the coil position command signal should be a value in proportion to a radius of a circle tangent to a straight line Q₁L₁ with the point L as the center for the driving coil 150a, a radius of a circle tangent to a straight line Q₁M₁ with the point M as the center for the driving coil 150b, and a radius of a circle tangent to a straight line Q₁N₁ with the point N as the center for the driving coil 150c, respectively.

The radiuses of these circles are set as rₓ, r_{y}, rᵥ, and a sign of each of the coil position command signals rₓ, r_{y}, rᵥ are set as shown in FIG. 11. That is, the coil position command signal rₓ for moving the point L₁ to the first quadrant is set as positive and the coil position command signal r_{y} for moving the point L₁ to the second quadrant is set as negative, and similarly, the coil position command signal r_{y} for moving the point M₁ to the first quadrant is set as positive and the coil position command signal r_{y} for moving the point M₁ to the fourth quadrant is set as negative.

Also, the coil position command signal rᵥ for moving the point N₁ to below the V-axis is set as positive and the coil position command signal rᵥ for moving the point N₁ to above the V-axis is set as negative. Moreover, a sign of angle is positive in the clockwise. Therefore, when the moving frame 114 is rotated clockwise from the neutral position, the coil position command signal rₓ is positive, the coil position command signal r_{y} is negative and the coil position command signal rᵥ is negative.

The coordinates of the point Q₁ are set as (j, g), the coordinates of the point L₁ are set as (i, e), and the coordinates of the point N₁ are set as (k, h), and an angle formed by the V-axis and the Y-axis is set as α. Moreover, an auxiliary line A passing through the point M and parallel with the straight line Q₁L₁ and an auxiliary line B passing through the point L and parallel with the straight line Q₁M₁ are drawn, and an intersection between the auxiliary line A and the auxiliary line B is made as a point P.

When the sine theorem is applied to a right-angle triangle LMP, it results in the following equation.

$$\frac{\overline{LP}}{sin ( 45 ° + θ )} = \frac{\overline{MP}}{sin ( 45 ° - θ )} = \frac{\sqrt{2} R}{sin 90 °} = \sqrt{2} R \qquad ( 1 )$$

Thus, the following relations are established.
L̅P̅=R(cos θ+sin θ) (2)
M̅P̅=R(cos θ−sin θ) (3)
Also, when the coordinates e, g, h, i, j, k are represented by R, rₓ, r_{y}, rᵥ, θ, α, from the geometric relation and the equation (3), the following equations are obtained.
e=−r_{X} sin θ+R (4-1)
g=e−( M̅P̅−r_{Y})cos θ=−r_{X} sin θ+r_{Y} cos θ−R cos θ(cos θ−sin θ)+R (4-2)
h=−R cos α−r_{V} sin(α+θ) (4-3)
i=r_{X} cos θ (4-4)
j=i−( M̅P̅−r_{Y})sin θ=r_{X} cos θ+r_{Y} sin θ−R sin θ(cos θ−sin θ) (4-5)
k=−R sin α+r_{V} cos(α+θ) (4-6)
Moreover, the following relation is established for the right-angle triangle with the coordinates (k, g), (j, g), (k, h) as apexes.

$$\begin{matrix}\frac{j - k}{g - h} = tan ( α + θ ) \\ = \frac{sin ( α + θ )}{cos ( α + θ )} \\ = \frac{sin α cos θ + cos αsin θ}{cos αcos θ - sin α sin θ} \\ = \frac{\begin{matrix}{r}_{X} cos θ + {r}_{Y} sin θ - R sin θ ( cos θ - sin θ ) + \\ R sin α - {r}_{V} cos ( α + θ )\end{matrix}}{\begin{matrix}- {r}_{X} sin θ + {r}_{Y} cos θ - R cos θ ( cos θ - sin θ ) + \\ R + R cos α - {r}_{V} sin ( α + θ )\end{matrix}}\end{matrix} \qquad ( 5 )$$

Here, the relation of the equation (5) is expanded and organized, the following relation is obtained.
r_{X} cos α−r_{Y} sin α−r_{V}=R(sin α+cos α)sin θ+R sin θ (6)
Moreover, when the moving frame 114 makes translational motion, since θ=0, the equation (6) becomes as follows:
r_{X} cos α−r_{Y} sin α−r_{V}=0 (7)
Also, in the first embodiment, since α=45°, the relation of the equation (7) is simplified as follows.

$${r}_{V} = \frac{( {r}_{X} - {r}_{Y} )}{\sqrt{2}} \\ {r}_{V} = \frac{( {r}_{X} - {r}_{Y} )}{\sqrt{2}} \qquad ( 8 )$$

Therefore, in the first embodiment, when the center of the image stabilizing lens 116 is to make translational motion to the coordinates (j, g) by the lens position command signal, the coil position command signal rₓ in proportion to the size of the coordinate j is given to the driving coil 150a. Also, to the driving coil 150b, the coil position command signal r_{y} in corporation to the size of the coordinate g is given, while the coil position command signal rᵥ is given to the driving coil 150c after calculation by the equation (8).

The coil position command signal rₓ corresponds to the output signal of the calculation circuit 138a shown in FIG. 10, and the coil position command signal r_{y} corresponds to the output signal of the calculation circuit 138b shown in FIG. 10. Also, the coil position command signal rᵥ corresponds to the output signal of the calculation circuit 170 shown in FIG. 10 for carrying out calculation equivalent to the equation (8).

Since the moving frame 114 and the image stabilizing lens 116 are uniquely positioned based on each coil position command signal rₓ, r_{y}, rᵥ obtained by the lens position command signal in this way, unintentional rotation can be surely prevented even without a mechanism for regulating the rotation around the optical axis LA.

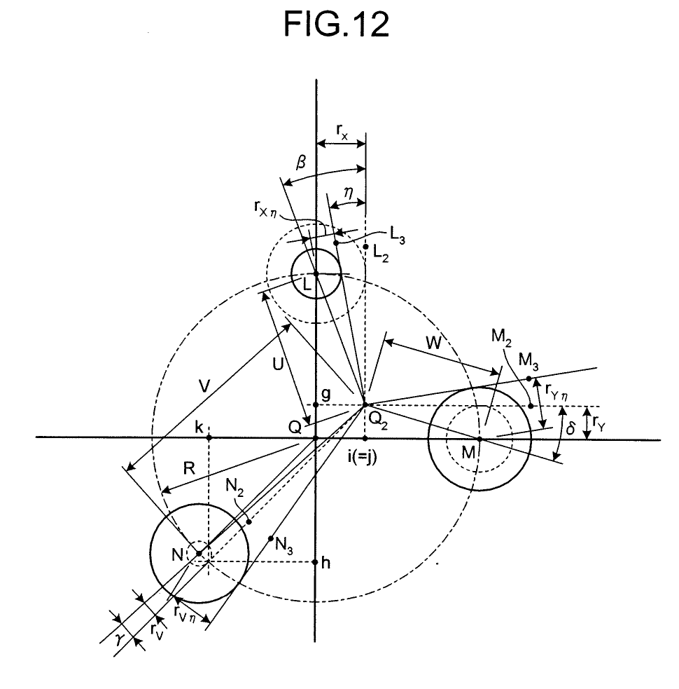

Next, the relation between the lens position command signal and the coil position command signal when the moving frame 114 is to make rotational motion will be described referring to FIG. 12. FIG. 12 is an explanatory diagram for explaining the coil position command signal when the moving frame makes translational motion and rotational motion. As shown in FIG. 12, when the moving frame 114 makes translational motion, the center of the image stabilizing lens 116 mounted on this moving frame 114 is moved from the point Q to the point Q₂, and the driving magnets 152 mounted on the moving frame 114 are moved from the points L, M, N to the points L₂, M₂, N₂, respectively.

Suppose that the coil position command signals for this translational motion are rₓ, r_{y}, rᵥ. The size of these coil position command signals can be acquired by the above equation (8) and the like. Here, the coil position command signals r_{xη}, r_{yη}, r_{vη} are calculated when the moving frame 114 is rotated counterclockwise by an angle η around the point Q₂.

First, similarly to FIG. 11, the coordinates of the point Q₂ are set as (j, g) and the coordinates of a contact point between the straight line Q₂N₂ and the radius rᵥ around the point N as (k, h), and when 0 is substituted to θ in the equation (4-1) to the equation (4-6), the following relation is obtained:

$$\begin{matrix}g = {r}_{Y} & ( 9 \text{-} 1 ) \\ j = i = {r}_{X} & ( 9 \text{-} 2 ) \\ k = - R sin α + {r}_{V} cos ( α + θ ) = - R \frac{1}{\sqrt{2}} + {r}_{V} \frac{1}{\sqrt{2}} & ( 9 \text{-} 3 )\end{matrix}$$

Next, when the moving frame 114 is rotated counterclockwise by the angle η around the point Q₂, the points L₂, M₂, N₂ are moved to the points L₃, M₃, N₃, respectively. Suppose that an angle made by the line segment Q₂L₂ and the line segment Q₂L as β, an angle made by the line segment Q₂M₂ and the line segment Q₂M as δ, and an angle made by the line segment Q₂N₂ and the line segment Q₂N as γ.

Moreover, the length of the line segment Q₂L is set as U, the length of the line segment Q₂M as W and the length of the line segment Q₂N as V. Here, since the size of the coil position command signals r_{xη}, r_{yη}, r_{vη} are equal to the radiuses of the circles tangent to the straight lines Q₂L₃, Q₂M₃, and Q₂N₃ around the points L, M, N, respectively, the following relation is established.
r_{Xη}=U sin(β+η)=U(sin β cos η+cos βsin η) (10-1)
r_{Vη}=V sin(γ+η)=−V(sin γ cos η+cos γ sin η) (10-2)
r_{Yη}=−W sin(δ+η)=−W(sin δ cos η+cos δ sin η) (10-3)
Also, sinβ, cosβ and the like can be represented as follows from the geometric relation.

$$\begin{matrix}sin β = \frac{i}{U} = \frac{{r}_{X}}{U} & ( 11 \text{-} 1 ) \\ cos β = \frac{R - g}{U} = \frac{R - {r}_{Y}}{U} & ( 11 \text{-} 2 ) \\ sin γ = - \frac{{r}_{V}}{V} & ( 11 \text{-} 3 ) \\ cos γ = \frac{\sqrt{2} ( i - k )}{V} = \frac{\sqrt{2} {r}_{X} + R - {r}_{V}}{V} & ( 11 \text{-} 4 ) \\ sin δ = \frac{g}{W} = \frac{- {r}_{Y}}{W} & ( 11 \text{-} 5 ) \\ cos δ = \frac{R - i}{W} = \frac{R - {r}_{X}}{W} & ( 11 \text{-} 6 )\end{matrix}$$

Moreover, when the relation of the equations (11-1) to (11-6) is substituted to the equations (10-1) to (10-3) and β, γ, δ are eliminated, the following relation is obtained.
r_{Xη}=r_{X} cos η+(R−r_{Y})sin η (12-1)
r_{Nη}=r_{V} cos η(\sqrt{2}r_{X}+R −r_{V})sin η (12-2)
r_{Yη}=r_{Y} cos η−(R−r_{X})sin η (12-3)
Thus, in order to have the center of the image stabilizing lens 116 make the translational motion to the coordinates (j, g) and further to move the moving frame 114 to the position obtained by counterclockwise rotational motion around the point by the angle η, the following procedure is needed.

That is, first, rₓ, r_{y}, rᵥ are calculated by the equation (8) and the equation (9-1) to the equation (9-3) and then, the value is substituted to the equation (12-1) to the equation (12-3) to calculate the coil position command signals r_{xη}, r_{yη}, r_{vη}, and the results are given to each of the driving coils 150a to 150c.

Also, if the moving frame 114 is not to make translational motion but only counterclockwise rotational motion around the point Q by the angle η, the coil position command signals r_{xη}, r_{yη}, r_{vη} can be calculated by the following equations in which 0 is substituted to rₓ, r_{y}, rᵥ in the equation (12-1) to the equation (12-3).
r_{Xη}=R sin η (13-1)
r_{Vη}=R sin η (13-2)
r_{Yη}=−R sin η (13-3)

Since the moving frame 114 and the image stabilizing lens 116 are uniquely positioned based on each coil position command signal r_{xη}, r_{yη}, r_{vη} obtained by the lens position command signal in this way, unintentional rotation can be surely prevented even without a mechanism for regulating the rotation around the optical axis LA.

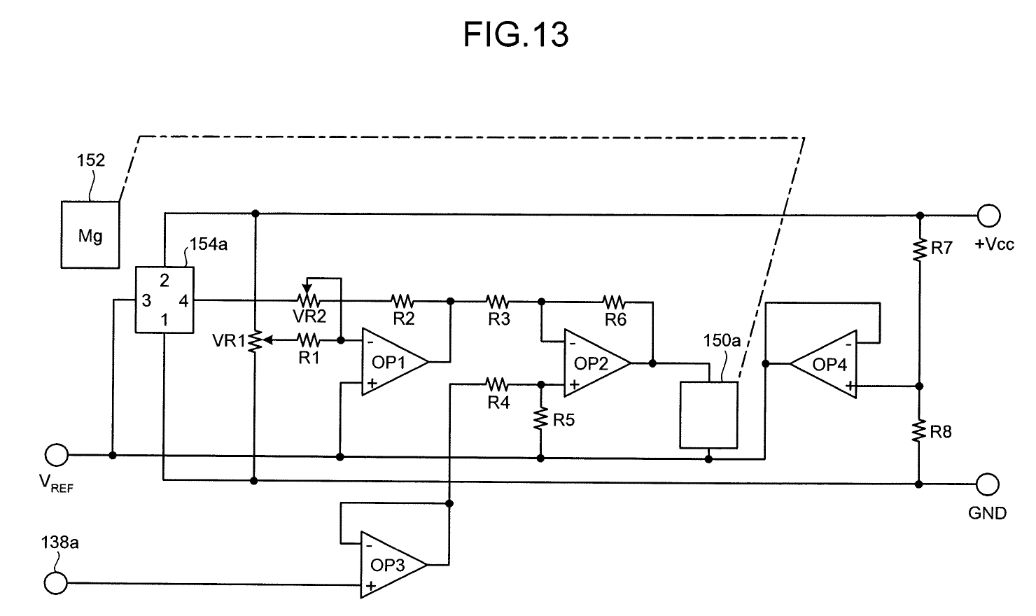

Next, an example of a specific circuit of the controller 136 incorporated in the lens unit 120 will be described referring to FIG. 13. FIG. 13 is a circuit diagram showing an example of a circuit that controls an electric current to be output to the driving coil. In the circuit shown in FIG. 13, accessory circuits such as a power-supply line that operates each operational amplifier is omitted. Also, the magnetic sensor 154a is supposed to use those other than the hall element.

First, as shown in FIG. 13, an electric resistance R7 and an electric resistance R8 are connected in series between a power voltage+Vcc and an earth potential GND. The positive input terminal of an operational amplifier OP4 is connected between the electric resistance R7 and the electric resistance R8. Moreover, the negative input terminal of the operational amplifier OP4 is connected to the output terminal of the operational amplifier OP4. By this, a voltage of the output terminal of the operational amplifier OP4 is set and maintained by the electric resistance R7 and the electric resistance R8 to a reference voltage V_{REF} between the power voltage+Vcc and the earth potential GND.

On the other hand, the power voltage+Vcc is applied between a first terminal and a second terminal of the magnetic sensor 154a. A third terminal of the magnetic sensor 154a is connected to the reference voltage V_{REF}. By this, when a magnetic field acting on the magnetic sensor 154a is changed, the voltage of a fourth terminal of the magnetic sensor 154a is changed between the power voltage+Vcc and the earth potential GND.

The fourth terminal of the magnetic sensor 154a is connected to a negative input terminal of an operational amplifier OP1 through a variable resistance VR2, and by regulating the variable resistance VR2, a gain of the output of the magnetic sensor 154a is regulated. Both fixed terminals of a variable resistance VR1 are connected to the power voltage+Vcc and the earth potential GND, respectively. A movable terminal of the variable resistance VR1 is connected to the negative input terminal of the operational amplifier OP1 through an electric resistance R1.

By regulating the variable resistance VR1, an offset voltage of the output of the operational amplifier OP1 is regulated. The positive input terminal of the operational amplifier OP1 is connected to the reference voltage V_{REF}. The output terminal of the operational amplifier OP1 is connected to the negative input terminal of the operational amplifier OP1 through an electric resistance R2.

The calculation circuit 138a that outputs a coil position command signal to the driving coil 150a is connected to the positive input terminal of an operational amplifier OP3. An output terminal of the operational amplifier OP3 is connected to the negative input terminal of the operational amplifier OP3. Therefore, the operational amplifier OP3 functions as a buffer amplifier of the coil position command signal.

The output terminal of the operational amplifier OP1 is connected to the negative input terminal of the operational amplifier OP2 through an electric resistance R3. An output terminal of the operational amplifier OP3 is connected to the positive input terminal of the operational amplifier OP2 through an electric resistance R4. Therefore, a difference between the output of the magnetic sensor 154a and the coil position command signal is output from the output terminal of the operational amplifier OP2.

The positive input terminal of the operational amplifier OP2 is connected to the reference voltage V_{REF} through an electric resistance R5, and the output terminal of the operational amplifier OP2 is connected to the negative input terminal of the operational amplifier OP2 through an electric resistance R6. By the electric resistance R5 and the electric resistance R6, gains on the negative and the positive side are set.

The output terminal of the operational amplifier OP2 is connected to one end of the driving coil 150a, and the other end of the driving coil 150a is connected to the reference voltage V_{REF}. Therefore, an electric current corresponding to a potential difference between the output of the operational amplifier OP2 and the reference voltage V_{REF} flows through the driving coil 150a. When the electric current flows through the driving coil 150a, a magnetic field is generated, which acts a magnetic force on the driving magnet 152 to move the driving magnet 152.

This magnetic force acts in the direction where the driving magnet 152 approaches the position designated by the coil position command signal. When the driving magnet 152 is moved, the voltage output from the fourth terminal of the magnetic sensor 154a is changed. When the driving magnet 152 is moved to the position designated by the coil position command signal, the voltage input to the positive input terminal and the negative input terminal of the operational amplifier OP2 becomes equal, and the electric current does not flow through the driving coil 150a any more.

The operational amplifier OP1 shown in the above FIG. 13 corresponds to the magnetic sensor amplifier 172a shown in FIG. 10, and the operational amplifier OP2 shown in FIG. 13 corresponds to the differential circuit 174a shown in FIG. 10. In FIG. 13, a circuit that controls the electric current to be output to the driving coil 150a has been described, but the current to be output to the driving coil 150b can be also controlled by the totally same circuit.

Moreover, the electric current to be output to the driving coil 150c can be also controlled by the same circuit as above, but in this case, the output of the calculation circuit 170 shown in FIG. 10 is connected to the positive input terminal of the operational amplifier OP3 shown in FIG. 13. The calculation circuit 170 can be included by the same differential circuit as the operational amplifier OP2 shown in FIG. 13 and an electric resistance that divides the output to (½)^{1/2}.

Next, operation of the camera 100 according to the first embodiment of the present invention will be described referring to FIGS. 1 and 10. First, by turning on a start switch (not shown) of a camera-shake prevention function of the camera 100, the actuator 110 provided at the lens unit 120 is operated. The gyros 134a, 134b mounted on the lens unit 120 detects vibration in a predetermined frequency band from hour to hour and outputs it to the calculation circuits 138a, 138b incorporated in the controller 136.

The gyro 134a outputs a signal of an angular velocity in the yawing direction of the lens unit 120 to the calculation circuit 138a, while the gyro 134b outputs a signal of an angular velocity in the pitching direction of the lens unit 120 to the calculation circuit 138b. The calculation circuit 138a calculates a yawing angle by one time integration of the input angular velocity signal, adds predetermined modification signal to this, and generates a lens position command signal in the horizontal direction.

Similarly, the calculation circuit 138b calculates a pitching angle by one time integration of the input angular velocity signal, adds a predetermined modification signal to this, and generates a lens position command signal in the vertical direction. By moving the image stabilizing lens 116 together with the moving frame 114 to the position designated by the lens position command signal output from hour to hour in a time series by the calculation circuits 138a, 138b in this way, an image focused on the film face F of the camera body 140 is stabilized.

The horizontal lens position command signal output by the calculation circuit 138a is input to the differential circuit 174a as the coil position command signal rₓ to the driving coil 150a. Similarly, the vertical lens position command signal output by the calculation circuit 138b is input to the differential circuit 174b as the coil position command signal r_{y} to the driving coil 150b. Also, the output of the calculation circuits 138a, 138b are input to the calculation circuit 170, and the coil position command signal rᵥ to the driving coil 150c is generated by the calculation represented by the equation (8).

On the other hand, the magnetic sensor 154a arranged in an inner gap portion of the driving coil 150a outputs a detection signal to the magnetic sensor amplifier 172a, the magnetic sensor 154b arranged in an inner gap portion of the driving coil 150b to the magnetic sensor amplifier 172b, and the magnetic sensor 154c arranged in an inner gap portion of the driving coil 150c to the magnetic sensor amplifier 172c, respectively. And the detection signals of the magnetic sensors 150a to 150c amplified by the magnetic sensor amplifiers 172a to 172c, respectively, are input to the differential circuits 174a to 174c, respectively.

The differential circuits 174a to 174c generate voltages according to the differences between the input detection signals of the magnetic sensors 154a to 154c and the coil position command signals rₓ, r_{y}, rᵥ, respectively, and output electric currents in proportion to the voltages to the driving coils 150a to 150c. When the electric current flows through each of the driving coils 150a to 150c, a magnetic field in proportion to the current is generated.

By this magnetic field, each of the driving magnets 152 arranged corresponding to each of the driving coils 150a to 150c receives a driving force in the direction approaching the position designated by the coil position command signals rₓ, r_{y}, rᵥ, respectively. When each of the driving magnets 152 receives the driving force, the columnar member 118 that supports the moving frame 114 and the fixed plate 112 in parallel is slightly deflected and moves the moving frame 114 on which the driving magnets 152 are mounted translationally or rotationally on the same plane.

At this time, since the columnar member 118 is deflected and deformed while maintaining a predetermined interval between the fixed plate 112 and the moving frame 114, the fixed plate 112 and the moving frame 114 are not brought into contact with each other, and since sliding resistance is not generated, the moving frame 114 is moved smoothly with a small driving force.

When the driving magnet 152 reaches the position designated by the coil position command signals by this driving force, the coil position command signals match the detection signals of the magnetic sensors 154a to 154c, and the output of the differential circuits 174a to 174c becomes 0 and the driving force also becomes 0. Also, if each of the driving magnets 152 is displaced from the position designated by the coil position command signals due to disturbance or change in the coil position command signal, an electric current is made to flow again through the driving coils 150a to 150c and each of the driving magnets 152 is returned to the position designated by the coil position command signals.

Since the above operation is repeated from hour to hour, the image stabilizing lens 116 mounted on the moving frame 114 provided with each of the driving magnets 152 is moved together with the moving frame 114, following the lens position command signal. By this, an image focused on the film face F of the camera body 140 through the lens unit 120 is stabilized.

With the camera 100 according to the first embodiment, the moving frame 114 of the actuator 110 for image stabilization can be moved to an arbitrary direction without using conventional guiding units arranged in two directions orthogonal to each other, and the actuator 110 can be realized by a simple construction. Also, in the camera 100 according to the first embodiment of the present invention, the moving frame 114 of the actuator 110 for image stabilization can make translational motion or rotational motion in an arbitrary direction on a predetermined plate.

Moreover, with the camera 100 according to the first embodiment of the present invention, since the moving frame 114 of the parallel moving device 111 provided at the actuator 110 is supported by the columnar members 118 in parallel with respect to the fixed plate 112, sliding resistance is not substantially generated at movement of the moving frame 114, and the moving frame 114 can be moved smoothly with a small driving force.

Furthermore, by simplifying the mechanism of the parallel moving device 111, the weight of the moving frame 114 of the parallel moving device 111 can be reduced, and since the moving frame 114 can be moved with a small driving force, the actuator 110 capable of high-speed and linear response can be realized.

The first embodiment of the present invention has been described as above, but it is needless to say that various changes can be made to the above first embodiment. For example, in the description of the first embodiment, the present invention is applied to a film camera, but the present invention can be also applied to an arbitrary camera for photographing a still image or a moving image such as a digital camera and a video camera.

Also, the present invention can be applied to a lens unit used with a camera body of these cameras. Moreover, the present invention can be applied to a parallel moving mechanism for movement in an arbitrary direction such as an XY stage as well as to driving of an image stabilizing lens of a camera. Since these technologies are publicly known the description will be omitted.

Also, in the above first embodiment, the columnar member 118 is constructed by a resin molding member provided with an elasticity integrally molded with at least one of the fixed plate 112 and the moving frame 114 as an example, but the columnar member 118 can be molded separately from them. In this case, the columnar member 118 may be mounted on the fixed plate 112 and the moving frame 114 by adhesion, heat welding, ultrasonic fusion, soldering and the like.

In the above first embodiment, the moving frame 114 is supported in parallel by the three columnar members 118 with respect to the fixed plate 112, but the moving frame 114 may be supported in parallel by four or more columnar members 118, for example. Also, the driving coils 150a to 150c are mounted on the fixed plate 112, which is a fixed member, and the driving magnets 152 are mounted on the moving frame 114, which is a movable member, but to the contrary, the driving magnets 152 may be mounted on the fixed plate 112 and the driving coils 150a to 150c on the moving frame 114.

Moreover, in the above first embodiment, three pairs of the driving coils 150a to 150c and the driving magnets 152 are used, but four or more pairs of the driving coils 150a to 150c and the driving magnets 152, for example, may be also used. Also, permanent magnets are used as the driving magnets 152, but electromagnets can be also used, for example.

Also, in the above first embodiment, the magnetic sensors 154a to 154c are used that detect magnetism of the driving magnets 152 and measure the positions as the position detecting units, but position detection sensors included by those other than the magnetic sensors 154a to 154c that detect the position of each of the driving magnets 152 with respect to each of the driving coils 150a to 150c may be used as the position detecting units.

Moreover, in the above first embodiment, the driving coils 150a to 150C are arranged on the fixed plate 112 so that a center angle between the driving coils 150a and 150b is 90° and a center angle between the driving coil 150c and the driving coil 150a as well as the driving coil 150b is 135°, but the driving coil 150c may be arranged so that the center angle between the driving coil 150b and the driving coil 150c is (90+α)° (0≦α≦90).

In this case, the coil position command signal to the driving coil 150c can be calculated from the equation (7). Also, the center angle between the driving coils 150a and 150b may not be 90° but the center angle between each of the driving coils 150a to 150c may be set to an arbitrary angle not less than 90° and not more than 180° such as 120°, for example, and each of the driving magnets 152 may be arranged at a corresponding position.

Also, in the above first embodiment, all the magnetization border lines C of the driving magnets 152 are directed to the radial direction, but the magnetization border line C of each driving magnet 152 may be directed to an arbitrary direction. However, at least one of the magnetization border lines C of the driving magnets 152 is preferably directed substantially to the radial direction in the arrangement.

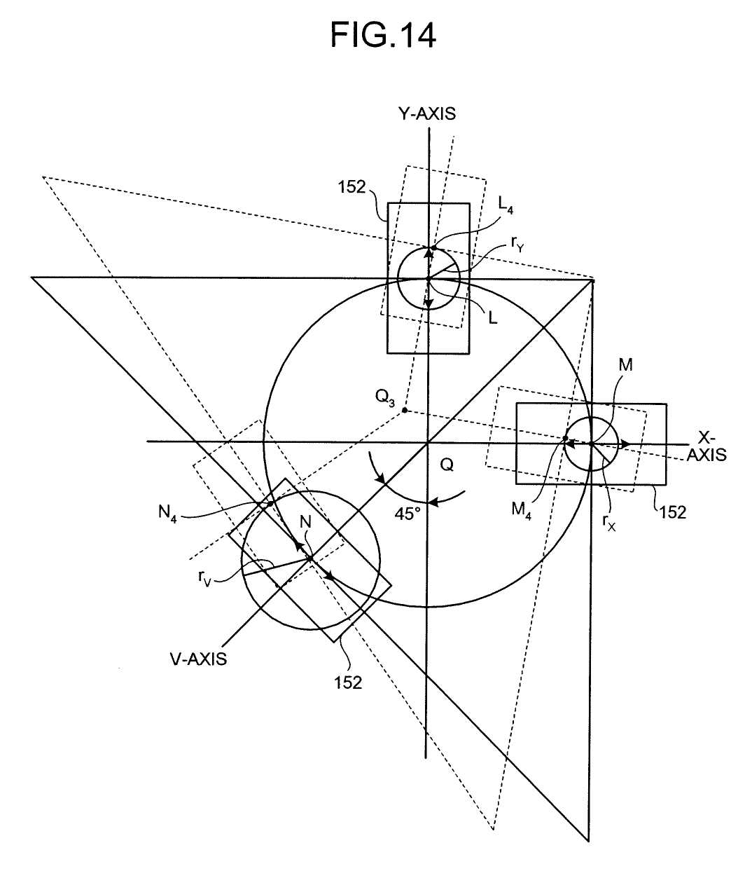

FIG. 14 is a diagram for explaining modification of arrangement of the driving magnets 152 in the first embodiment. FIG. 14 illustrates the modification that the magnetization border lines of the driving magnets 152 corresponding to the driving coils 150a and 150b are directed toward the tangent direction of a circle around the point Q and the magnetization border line of the driving magnet 152 corresponding to the driving coil 150c is directed to the radial direction. Though not shown, the driving coil 150a is arranged at the point L, the driving coil 150b at the point M, and the driving coil 150c at the point N, respectively.

In this variation, the coil position command signal rₓ to the driving coil 150a arranged at the point L, the coil position command signal r_{y} to the driving coil 150b arranged at the point M, and the coil position command signal rᵥ to the driving coil 150c arranged at the point N are given, respectively. By these coil position command signals, the middle points of the magnetization border lines of the driving magnets 152 located on the points L, M, N at the neutral position of the moving frame 114 are moved to the points L₄, M₄, N₄, respectively, and the center point of the image stabilizing lens 116 is moved from the point Q to the point Q₃.

In this variation, the coil position command signal rₓ corresponding to the horizontal component of the lens position command signal is given to the driving coil 150b arranged at the point M, and the coil position command signal r_{y} corresponding to the vertical component of the lens position command signal is given to the driving coil 150a arranged at the point L. In the variation shown in FIG. 14, when the coil position command signals rₓ, r_{y} are substituted to the equation (8), respectively, and the acquired coil position command signal rᵥ is given to the driving coil 150c, the point Q makes translational motion by −rₓ in the X-axis direction and r_{y} in the Y-axis direction.

Since the moving frame 114 and the image stabilizing lens 116 are uniquely positioned in this way based on the coil position command signals rₓ, r_{y}, rᵥ, respectively, obtained by the lens position command signals, unintentional rotation can be surely prevented even without a mechanism that regulates rotation around the optical axis LA.

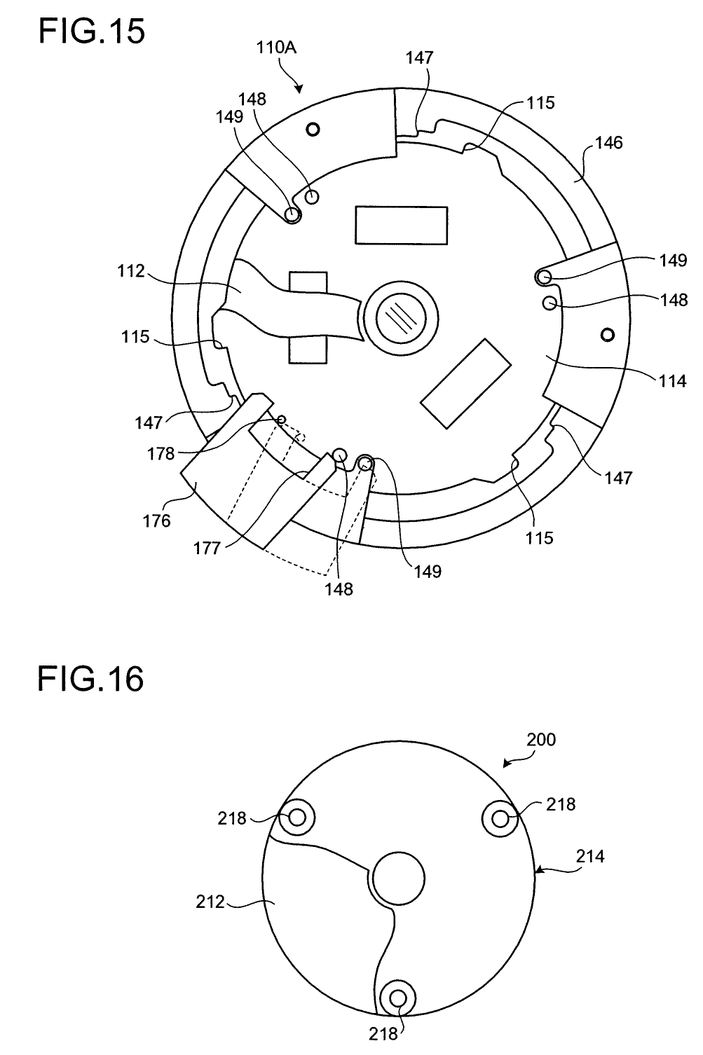

FIG. 15 is a diagram for explaining another modification of the actuator provided in the camera according to the first embodiment of the present invention. An actuator 110A of this variation is different from the actuator 110 described in the above first embodiment in the point that a locking mechanism is provided that locks/fixes the moving frame 114 to the fixed plate 112 when the moving frame 114 is not controlled.

As shown in FIG. 15, in the actuator 110A of this variation, three engagement projections 115 in the shape projecting outward are formed on the outer circumference side of the moving frame 114, for example. Also, at the fixed plate 112 (only a part thereof is shown), an annular member 146 arranged surrounding the outer circumference side of the moving frame 114 is mounted, and on the inner circumference side of this annular member 146, three engagement portions 147 formed in the shape capable of engagement with the engagement projections 115, respectively, are provided. Moreover, near the outer circumference of the moving frame 114, three movable-side holding magnets 148 are mounted.

Also, at the positions corresponding to the movable-side holding magnets 148 on the inner circumference portion of the annular member 146, three fixed-side holding magnets 149 positioned so that a magnetic force mutually acts with respect to the movable-side holding magnets 148 are provided, respectively. Moreover, a manual locking member 176 operated manually is provided extending toward the radial direction of the actuator 110A from the outside of the annular member 146, capable of movement in the circumferential direction of the annular member 146.

At the tip end side of this manual locking member 176, a recess portion 177 with the horizontal section in the U shape, for example, is formed. An engagement pin 178 formed near the outer circumference of the moving frame 114 so that it is fitted inside the recess portion 177 in the U shape and engaged with the manual locking member 176 when the moving frame 114 is locked/fixed.

Next, operation of the actuator 110A will be briefly described. When the moving frame 114 of the actuator 110A shown in FIG. 15 is rotated/driven counterclockwise, the engagement projections 115 on the outer circumference side of the moving frame 114 are engaged with the engagement portions 147 of the annular member 146, and the moving frame 114 is locked/fixed to the fixed plate 112.

The movable-side holding magnets 148 provided at the moving frame 114 and the fixed-side holding magnets 149 provided at the annular member 146 hardly exert a magnetic force to each other in the state as shown in FIG. 15. For example, when the moving frame 114 is rotated/driven counterclockwise and the movable-side holding magnet 148 approaches the fixed-side holding magnet 149, the fixed-side holding magnet 149 exerts the magnetic force to the moving frame 114 in the direction to rotate the moving frame 114 clockwise.

Against this magnetic force, the moving frame 114 is rotated/driven counterclockwise, and when the movable-side holding magnet 148 passes the fixed-side holding magnet 149, the fixed-side holding magnet 149 exerts the magnetic force to the moving frame 114 in the direction to rotate the moving frame 114 counterclockwise. By this magnetic force, the engagement projections 115 are pressed onto the engagement portions 147, and engagement between the engagement projections 115 and the engagement portions 147 is maintained. Therefore, even when the actuator 110A is powered off and its driving force does not exist any more, the engagement between the engagement projections 115 and the engagement portions 147 is maintained, and the moving frame 114 is locked/fixed to the fixed plate 112.

When the manual locking member 176 is rotated/moved counterclockwise manually in FIG. 15, the engagement pin 178 of the moving frame 114 is engaged with the recess portion 177 in the U shape, and the moving frame 114 is also rotated/moved counterclockwise. Then, the engagement projections 115 and the engagement portions 147 are engaged manually.

On the contrary, when the manual locking member 176 is rotated/moved manually clockwise in FIG. 15, the moving frame 114 is rotated/moved clockwise, and engagement between the engagement projections 115 and the engagement portions 147 are released. Since the actuator 110 in the first embodiment can rotate/move the moving frame 114, the locking mechanism such as the actuator 110A of this variation can be realized with an easy and simple structure.

A parallel moving device according a second embodiment of the present invention is provided with a construction corresponding to the actuator 110 used in the camera 100 according to the first embodiment excluding the driving means, for example. Therefore, the same reference numerals are given to the part duplicated with the already described part and the description will be omitted in the following.

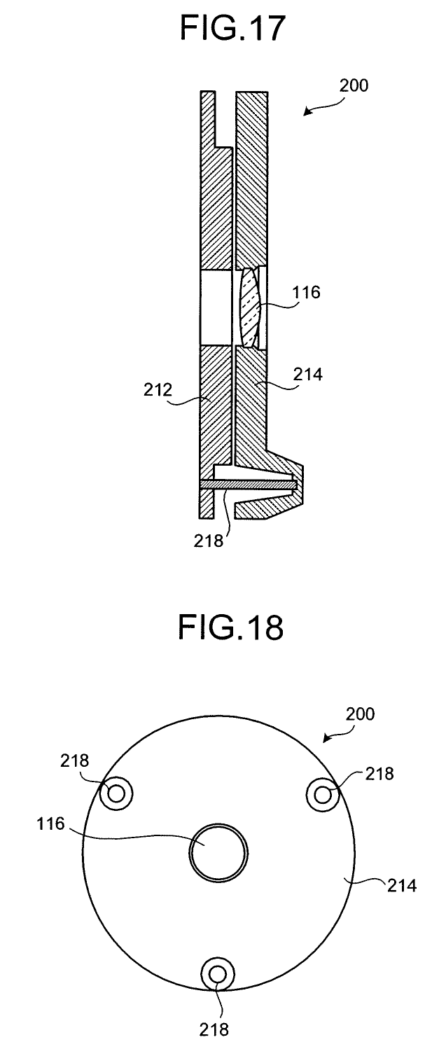

FIG. 16 is a partially broken view of a front portion of a parallel moving device 200. FIG. 17 is a side cross-section of the parallel moving device 200. FIG. 18 is a rear view of the parallel moving device 200. FIG. 16 is a view showing the parallel moving device 200 seen from a fixed plate 212 side, and though the fixed plate 212 is partially broken, this is referred to as a front view for convenience.

As shown in FIGS. 16 to 18, the parallel moving device 200 includes the fixed plate 212, which is a fixed member, a moving frame 214, which is a movable member supported movably with respect to this fixed plate 212, and three columnar members 218 provided with elasticity, which are support members that support the fixed plate 212 and the moving frame 214 in parallel. At the center part of the moving frame 214, the image stabilizing lens 116 is mounted.

The three columnar members 218 are connected/fixed to the fixed plate 212 and the moving frame 214, respectively, at both ends in the axial direction and arranged so that a predetermined interval is formed between the fixed plate 212 and the moving frame 214. Each of the columnar members 218 is arranged at a position separated from the adjacent columnar member 218 with a center angle of 120°, for example, respectively.

When the parallel moving device 200 according to this second embodiment is to be used, it is only necessary to have a driving force generated by an arbitrary driving unit to the moving frame 214, for example, so that the moving frame 214 is moved in a plane parallel with the fixed plate 212. At this time, the moving frame 214 is moved in parallel with the fixed plate 212 since the three columnar members 218 are defected and deformed in the moving direction.

Since the moving frame 214 is supported by the three columnar members 218 in parallel, sliding resistance or resistance caused by contact hardly act on the moving frame 214 at movement. Therefore, with the parallel moving device 200 according to the second embodiment of the present invention, since various resistances hardly act on the movement of the moving frame 214, the moving frame 214 can be moved with a small driving force.

An actuator according to a third embodiment of the present invention corresponds to the actuator 110 used in the camera 100 according to the first embodiment, for example, but different in the point that the moving frame is attracted to the fixed plate by elasticity of an elastic member.

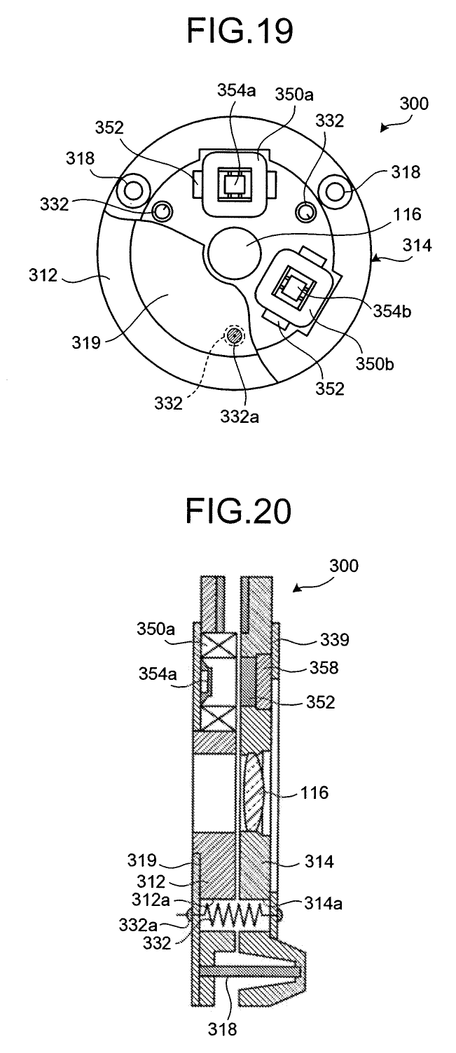

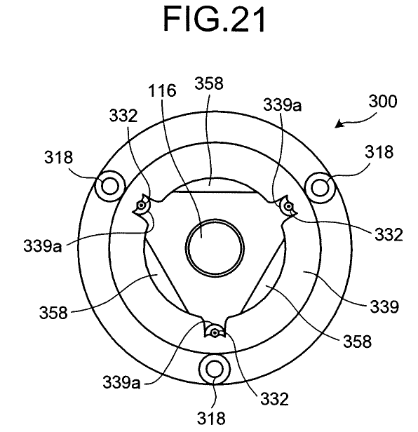

FIG. 19 is a partially broken view of a front part of an actuator 300. FIG. 20 is a rear view of the actuator 300. FIG. 21 is a rear view of the actuator 300. FIG. 19 is a view showing the actuator 300 seen from a fixed plate 312, and the fixed plate 312 is shown in the partially broken state, but this is referred to as a front view for convenience.

As shown in FIGS. 19 to 21, the actuator 300 includes the fixed plate 312, which is a fixed member, a moving frame 314, which is a movable member on which the image stabilizing lens 116 is mounted, and three columnar members 318, which are support members. The three columnar members 318 constitute a movable-member support unit that fixes the moving frame 314 to the fixed plate 312.

The actuator 300 includes three driving coils 350a, 350b, 350c (350c is not shown) mounted on the fixed plate 312, three driving magnets 352 (only two of them are shown) mounted at positions corresponding to the driving coils 350a to 350c in the moving frame 314, respectively, and magnetic sensors 354a, 354b, 354c (354c is not shown), which are position detecting units arranged in inner gap portions of the driving coils 350a to 350c.

The actuator 300 is also provided with back yokes 358 mounted on the back of the driving magnets 352, respectively, so that a magnetic force of each of the driving magnets 352 is directed to the fixed plate 312 effectively. The driving coils 350a to 350c and the driving magnets 352 constitute a driving unit that is capable of translational motion or rotational motion of the moving frame 314 with respect to the fixed plate 312.

As shown in FIG. 19, the three columnar members 318 are arranged on the circumference outside the circumference where the driving coils 350a to 350c of the fixed plate 312 are arranged, respectively. The three columnar members 318 are arranged with an interval of a center angle of 120°, for example, and the columnar members 318 are arranged so that they are located between each of the driving coils 350a to 350c, respectively.

As shown in FIG. 20, each of the columnar members 318 is arranged between the fixed plate 312 and the moving frame 314 so that the both are supported in parallel. Therefore, the moving frame 314 is supported on a plane in parallel with the fixed plate 312, and by deflection and deformation of each of the columnar members 318, the moving frame 314 is allowed translational motion or rotational motion in an arbitrary direction with respect to the fixed plate 312. Since each of the columnar members 318 is deformed while being deflected with a predetermined interval between the fixed plate 312 and the moving frame 314, even if the moving frame 314 is moved with respect to the fixed plate 312, no sliding friction or resistance caused by contact is generated between the both.

The fixed plate 312 is made of a doughnut-shaped disk member having a space at the center part, for example, and a fixed-plate side substrate 319 similarly made of a doughnut-shaped disk member is mounted at a predetermined position on the concentric circle with the fixed plate 312. The moving frame 314 is also made of a substantially doughnut-shaped disk member and a moving-frame side substrate 339 made of a similarly doughnut-shaped disk member is mounted at a predetermined position of a concentric circle.

As shown in FIG. 20, on the circumferences of the fixed plate 312 and the moving frame 314, three through holes 312a and 314a are provided, respectively, with an interval of a center angle of 120°, for example, and the positions of the through holes 312a and 314a are aligned with each other. Inside each of the through holes 312a and 314a, a spring 332, which is an elastic body, for example, is arranged, respectively.

One end of each spring 332 extends in the straight state in the axial direction of the spring 332, while a hook (not shown) is formed at the other end. The straight end of each spring 332 is passed through a small hole (not shown) drilled at a position corresponding to each of the through holes 312a of the fixed-plate side substrate 319 and directly connected to the fixed-plate side substrate 319 by a solder 332a or the like. On the other hand, the end of each spring 332 where the hook is formed is hooked by a claw portion 339a formed at a position of each through hole 314a of the moving-frame side substrate 339 and directly connected to the moving-frame side substrate 339 by the solder 332a or the like.

Since the hook of each spring 332 is hooked by a claw portion 339a in the stretched state, the moving frame 314 is pulled by an elastic force of each spring 332 toward the fixed plate 312 and attracted. Therefore, a structure is realized that the function can be fully exerted even if both ends of each columnar member 318 in the axial direction is not connected/fixed to the both between the fixed plate 312 and the moving frame 314.

Also, the through holes 312a and 314a are formed in the size having a sufficient diameter so that the spring 332 is not brought into contact with the inner wall portions of the through holes 312a and 314a when the moving frame 314 is moved in parallel with the fixed plate 312 in an actual use range. Moreover, the moving-frame side substrate 339 mounted on the moving frame 314 and the fixed-plate side substrate 319 mounted on the fixed plate 312 are connected to each other by the spring 332, this spring 332 can be used as a conductor that transmits an electric signal between the fixed-plate side substrate 319 and the moving-frame side substrate 339, for example.

Since operation of the actuator 300 according to the third embodiment of the present invention is the same as that of the actuator 110 according to the first embodiment except that the moving frame 314 is attracted to the fixed plate 312 by the spring 332, the description will be omitted. With the actuator 300 according to the third embodiment, since no sliding resistance is generated against the moving frame 314, the moving frame 314 can be moved smoothly with a small driving force.

The rod-like columnar members 118, 218, 318 are formed from a resin material, a flexible resin material, a rubber material or a flexible material, but they may be formed from a rigid material or a rigid resin material. In this case, the columnar members 118, 218, 318 may be formed in the shape which can obtain appropriate elasticity and flexibility by reducing their thickness or the size of the outer circumferential diameter.

According to the embodiments described above, a movable member can be moved smoothly and with high accuracy in an arbitrary direction in a predetermined plane by translational motion and rotational motion.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2005-350345 filed in Japan on Dec. 5, 2005.

What is claimed is:

1. A parallel moving device comprising:
a fixed member that is mounted on a side of a casing;
a movable member that is mounted on a side of an optical system; and
a support member that is provided between the fixed member and the movable member to support both of the fixed member and the movable member while enabling movement of the movable member in a direction substantially perpendicular to an optical axis of the optical system, wherein
the support member connects the fixed member and the movable member in a direction along the optical axis, and is formed with an elastic member that supports the movable member in parallel with the fixed member.

2. The parallel moving device according to claim 1, further comprising:
a position detecting unit that includes at least three driving coils that are provided at either one of the fixed member and the movable member; and
a plurality of driving magnets that are provided at another one of the fixed member and the movable member such that each of the driving magnets is arranged at a portion corresponding to one of the driving coils respectively, the position detecting unit that detects positions of the driving magnets with respect to the driving coils based on action of a magnetic field; and
a control unit that controls movement of the movable member based on a result of detection by the position detecting unit so as to cancel vibration externally applied.

3. The parallel moving device according to claim 1, wherein the support member supports the fixed member and the movable member so that a predetermined interval is formed between the fixed member and the movable member.

4. The parallel moving device according to claim 1, wherein the support member is formed with a rod-like elastic member having an axis in the direction along the optical axis and arranged in plurality between the fixed member and the movable member.

5. The parallel moving device according to claim 1, wherein the support member is formed with a resin member integrally molded with at least one of the fixed member and the movable member.

6. The parallel moving device according to claim 1, wherein the support member is arranged such that an end thereof is fit in a concave fitting unit that is formed so as to have an opening on at least one of the fixed member and the movable member on a surface opposing to each other, the fitting unit having an opening.

7. An actuator comprising:
a fixed member that is mounted on a side of a casing;
a movable member mounted on a side of an optical system;
a support member that is provided between the fixed member and the movable member to support both of the fixed member and the movable member while enabling movement of the movable member in a direction substantially perpendicular to an optical axis of the optical system;
at least three driving coils that are provided at either one of the fixed member and the movable member;
a plurality of driving magnets that are provided at another one of the fixed member and the movable member such that each of the driving magnets is arranged at a portion corresponding to one of the driving coils respectively;
a position detecting unit that detects positions of the driving magnets with respect to the driving coils based on action of a magnetic field; and
a control unit that generates a coil position signal for each of the driving coils based on a signal indicating a position to which the movable member is to be moved so as to cancel vibration externally applied, and that controls a driving current to be fed to each of the driving coils, based on the coil position signal and a result of detection by the position detecting unit, wherein
the support member connects the fixed member and the movable member in a direction along the optical axis, and is formed with an elastic member that supports the movable member in parallel with the fixed member.

8. A lens unit comprising:
a lens barrel that accommodates a lens;
a fixed member that is mounted on the lens barrel;
a movable member on which an image stabilizing lens is mounted;
a support member that is provided between the fixed member and the movable member to support both of the fixed member and the movable member while enabling movement of the movable member in a direction substantially perpendicular to an optical axis of the image stabilizing lens;
at least three driving coils that are provided at either one of the fixed member and the movable member;
a plurality of driving magnets that are provided at another one of the fixed member and the movable member such that each of the driving magnets is arranged at a portion corresponding to one of the driving coils respectively;
a position detecting unit that detects positions of the driving magnets with respect to the driving coils based on action of a magnetic field;
a vibration detecting unit that detects vibration of the lens barrel;
a lens position signal generating unit that generates a lens position signal indicating a position to which the image stabilizing lens is to be moved, based on a result of detection by the vibration detecting unit; and
a control unit that generates a coil position signal for each of the driving coils based on the lens position signal, and that controls a driving current to be fed to each of the driving coils, based on the coil position signal and a result of detection by the position detecting unit, wherein
the support member connects the fixed member and the movable member in a direction along the optical axis, and is formed with an elastic member that supports the movable member in parallel with the fixed member.

9. A camera comprising a lens unit that includes
a lens barrel that accommodates a lens;
a fixed member that is mounted on the lens barrel;
a movable member on which an image stabilizing lens is mounted;
a support member that is provided between the fixed member and the movable member to support both of the fixed member and the movable member while enabling movement of the movable member in a direction substantially perpendicular to an optical axis of the image stabilizing lens;
at least three driving coils that are provided at either one of the fixed member and the movable member;
a plurality of driving magnets that are provided at another one of the fixed member and the movable member such that each of the driving magnets is arranged at a portion corresponding to one of the driving coils respectively;
a position detecting unit that detects positions of the driving magnets with respect to the driving coils based on action of a magnetic field;
a vibration detecting unit that detects vibration of the lens barrel;
a lens position signal generating unit that generates a lens position signal indicating a position to which the image stabilizing lens is to be moved, based on a result of detection by the vibration detecting unit; and
a control unit that generates a coil position signal for each of the driving coils based on the lens position signal, and that controls a driving current to be fed to each of the driving coils, based on the coil position signal and a result of detection by the position detecting unit, wherein
the support member connects the fixed member and the movable member in a direction along the optical axis, and is formed with an elastic member that supports the movable member in parallel with the fixed member.
